(19) United States
(12) Patent Application Publication
(10) Pub. No.: US 2006/0044577 A1
(43) Pub. Date: Mar. 2, 2006

(54) Systems and methods for transmissive optical sensing of media information encoding and print media and methods of making same

(76) Inventors: Aaron B. Weast, Camas, WA (US); Steven E. Soar, Vancouver, WA (US); Steven H. Walker, Camas, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/925,239

(22) Filed: Aug. 24, 2004

(51) Int. Cl. G06F 15/00

(52) U.S. Cl. 358/1.9

(57) ABSTRACT

Systems and methods for transmissive optical sensing of media information encoding are disclosed. In addition, print media and methods of making print media are disclosed. One embodiment of an exemplary method, among others, includes, advancing a portion of a print medium through a transmissive sensor assembly, the portion of the print medium having a barcode, the barcode being minimally transmissive of a set of light wavelengths, and the barcode being encoded with at least one type of information corresponding to the print medium; transmitting light at the set of light wavelengths substantially absorbed by the barcode through the print medium; and detecting changes in the light transmitted through the print medium, the changes being produced by the substantially absorptive barcode.

### BACKGROUND

Modern printers in offices and homes use many different types of print media to produce a desired product. The same printer may be used to print on traditional paper media, transparency media, photo media, or other print media. The various properties of these media types require that a corresponding printer mode be used for printing on each of these types of media in order to realize optimal print quality. For example, photo media with color mapping dissimilar to paper media may require a different print mode. Printing green on photo media may require a different ratio of yellow and cyan than printing green on paper media. Furthermore, there may be specific types of paper, transparency, photo media, etc. that require different print modes.

Even if users know of different print modes for the different media types, many users print with the default print mode. As a result, poor print quality results or the print medium is wasted because the product is unusable. In addition, print media has been developed to a point where there are a multitude of attributes to be considered when selecting a print mode. Media size, orientation, color map, and porous/swellable differentiation are just a few of the criteria that need to be considered in selecting a print mode. With so many considerations, it would therefore be advantageous for a printer to automatically select the proper print mode, without user interaction.

Print media that are capable of producing images having photographic image quality are typically categorized into two groups: porous media and swellable media. Porous media generally have an ink-receiving layer that is formed from porous, inorganic particles bound with a polymer binder. An ink-jet ink is absorbed into the pores of the inorganic particles and the colorant is fixed by mordants incorporated in the ink-receiving layer or by the surface of the inorganic particles. In swellable media, the ink-receiving layer is a continuous layer of a swellable, polymer matrix. When the inkjet ink is applied, the inkjet ink is absorbed by swelling of the polymer matrix and the colorant is immobilized inside the continuous layer.

Currently, there is no method or system of automatically differentiating between porous media and swellable media. Current media sense technology (diffuse and specular reflectance) is unable to reliably distinguish between these photo media types.

In addition, there is also no method or system for determining media page length until printing has already begun on the media page. If there is a mismatch between image size and media size, an incomplete image is printed or alternatively, overprint onto the printer's platen will result.

Further, current media sense technology also cannot determine specific color map information. Without specific knowledge of color maps, accurate color copies and printed photos cannot be produced.

Prior attempts at media sense technology has made reference to reflective systems of reading bar codes. These systems often require high power light source (e.g., for fluorescing ink) in addition to special light filters, which substantially increases costs associated with these printer systems.

### SUMMARY

Systems and methods for transmissive optical sensing of media information encoding are disclosed. In addition, print media and methods of making print media are disclosed. One embodiment of an exemplary method, among others, includes, advancing a portion of a print medium through a transmissive sensor assembly, the portion of the print medium having a barcode, the barcode being minimally transmissive of a set of light wavelengths, and the barcode being encoded with at least one type of information corresponding to the print medium; transmitting light at the set of light wavelengths substantially absorbed by the barcode through the print medium; and detecting changes in the light transmitted through the print medium, the changes being produced by the substantially absorptive barcode.

One embodiment of an exemplary printer system for communicating information about a print medium, among others, includes a transmissive sensor assembly configured to emit light and detect the light being transmitted through the print medium having a barcode. The barcode is minimally transmissive of the light and encoded with the information corresponding to the print medium. The transmissive sensor assembly includes at least one light source element and at least one optical sensor element.

One embodiment of an exemplary print medium, among others, includes a barcode, the barcode being minimally transmissive of a set of light wavelengths. In addition, the barcode can be encoded with at least one type of information corresponding to the print medium.

One embodiment of and exemplary method of making print media, among others, includes: providing a print medium; and disposing a barcode material on the print medium, the barcode material being minimally transmissive to a set of light wavelengths; and forming a barcode with the barcode material, wherein the barcode encodes at least one type of information corresponding to the print medium.

### BRIEF DESCRIPTION OF THE DRAWINGS

Many aspects of this disclosure can be better understood with reference to the following drawings. The components in the drawings are not necessarily to scale. Moreover, in the drawings, like reference numerals designate corresponding parts throughout the several views.

FIG. 1 illustrates a block diagram of an embodiment of a printer system.

FIG. 2 is a block diagram showing an embodiment of a transmissive sensor assembly for a printer system.

FIG. 3A illustrates a top view of a representative embodiment of a print medium having a minimally transmissive barcode.

FIG. 3B illustrates a cross-sectional view of another representative embodiment of a print medium having a minimally transmissive barcode.

FIG. 4 illustrates a flow diagram of a representative embodiment for using the transmissive sensor assembly illustrated in FIG. 2.

FIG. 5 illustrates a flow diagram of a representative embodiment for selecting a print mode.

### DETAILED DESCRIPTION

Methods and systems for transmissive optical sensing of media information encoding are described. In addition, media incorporating encoding information are also disclosed.

The use of transmissive sensing of media information encoding allows for automatic selection of print modes, thereby eliminating human error in the selection of the print mode. The print medium has a minimally transmissive barcode encoded therein and/or thereon with one or more types of information. In this regard, the use of transmissive sensing allows for faster printing, as print media is positioned early in the paper path and can be used to adjust the printer mode before the print medium advances to the print zone. In addition, transmissive sensors are relatively inexpensive and use relatively low power inputs, which thereby decrease costs associated with the print system. Moreover, minimally transmissive barcodes can be placed inside a print medium and are thereby substantially invisible to the user.

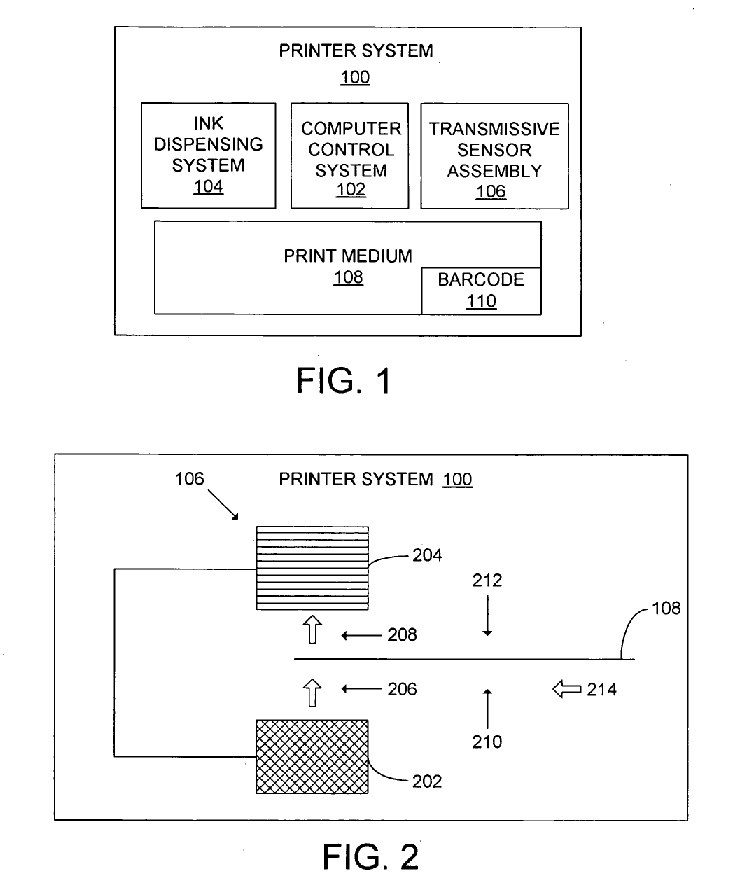

FIG. 1 illustrates a block diagram of a representative printer system 100 that includes, but is not limited to, a computer control system 102, an ink dispensing system 104, a transmissive sensor assembly 106, and a print medium 108. The computer control system 102 includes a process control system that is operative to control the ink dispensing system 104. In particular, the computer control system 102 instructs and controls the ink dispensing system 104 to print characters, symbols, photos, and the like, onto the print medium 108. In addition, the computer control system 102 includes a controller system to control the transmissive sensor assembly 106, store data from the transmissive sensor assembly 106, decode the data from the transmissive sensor assembly 106, and select the corresponding printer system mode for the print medium 108 based on the decoded data automatically without user input.

The ink dispensing system 104 includes, but is not limited to, ink-jet technologies and coating technologies, which dispense the ink onto the print medium 108. Ink-jet technology, such as drop-on-demand and continuous flow ink-jet technologies, can be used to dispense the ink. The ink dispensing system 104 can include at least one ink-jet printhead (e.g., thermal ink-jet printhead and/or a piezo ink-jet print head) operative to dispense (e.g., jet) the inks through one or more of a plurality of ink-jet printhead dispensers. Also, other types of ink dispensing technologies may be used including, but not limited to, dot matrix technology, dye-sublimation technology, and laser jet technology.

The transmissive sensor assembly 106 is configured to transmit light through the print medium 108 and detect transmitted light that is not substantially blocked and/or absorbed by the barcode 110 on the print medium 108. The barcode 110 is minimally transmissive to the transmitted light. In an embodiment, the light transmissive sensor assembly 106 is configured to detect transmitted light that is not substantially blocked, absorbed, scattered, reflected, or a combination thereof. The operation of the transmissive sensor assembly 106 and its components are discussed in greater detail below in reference to FIG. 2. Further description of transmissive sensor assemblies may also be found in U.S. patent application Ser. No. 10/679,079, which incorporated herein by reference.

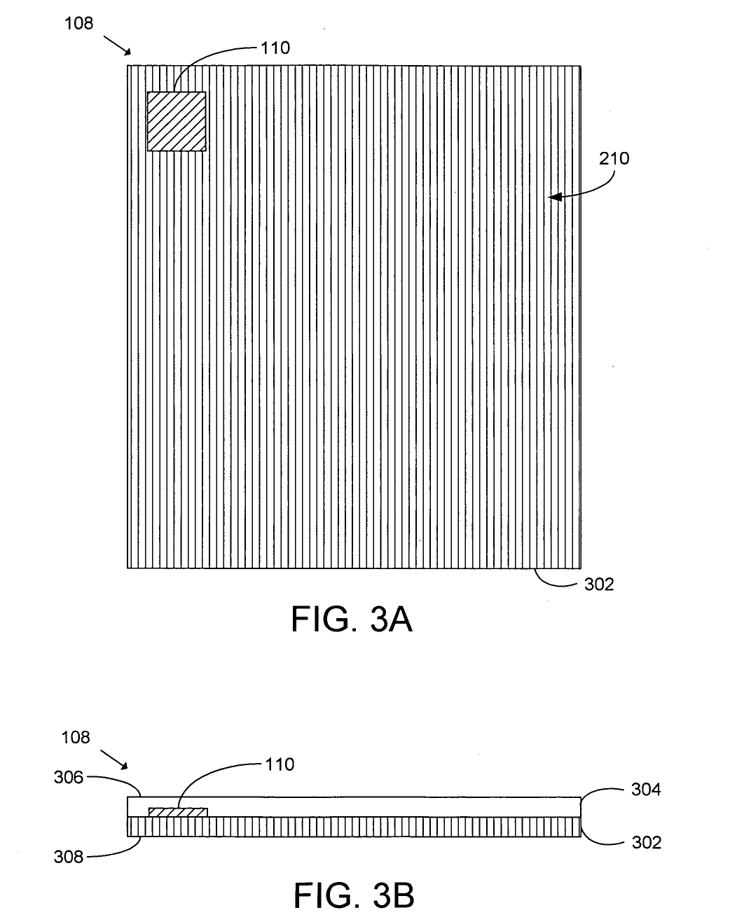

The print medium 108 may include, but is not limited to, paper stock, transparency, and photo media. The barcode 110 can be disposed on one side (e.g., the backside) of the print medium 108, both sides of the print medium, and/or inside the print medium 108. When the barcode 110 is disposed inside the print medium 108, the quality of the printed image on the front side and/or backside of the print medium 108 is not affected by the barcode 110. In general, the barcode 110 is minimally transmissive to the transmitted light. For example in one embodiment, the barcode 110 can substantially absorb the light. In another embodiment, the barcode 110 can substantially scatter the light, while in another embodiment, the barcode 110 can substantially reflect the light. In another embodiment, the barcode 110 can substantially absorb, scatter, and reflect the light. The print medium 108 and the barcode 110 are discussed in greater detail below in reference to FIG. 3.

FIG. 2 illustrates an embodiment of a transmissive sensor assembly 106 that can be incorporated in the printer system 100. The transmissive sensor assembly 106 includes, but is not limited to, a light source 202 and a transmissive optical sensor 204. The print medium 108 is advanced in direction 214 between the light source 202 and the transmissive optical sensor 204. The print medium 108 has a minimally transmissive barcode (not shown in FIG. 2) disposed on or in the print medium 108. The portion of the print medium 108 having the barcode is the first portion of the print medium 108 to pass between the light source 202 and the transmissive optical sensor 204. Thus, the computer control system 102 can select the appropriate print mode for the print medium 108 prior to its entering the print zone.

The light source 202 may include, but is not limited to, one or more light-emitting diodes (LED's), or other types of light sources. Examples of such light sources include fluorescing gas (e.g., neon), incandescent, filament, and/or halogen light sources. The wavelengths of light emitted may be, but are not limited to, ultra violet, infrared, and/or near infrared wavelengths. Specifically, the wavelength of light emitted is near infrared wavelength. In particular, the wavelengths can be centered around about 860 nanometers (nm), 940 nm, and others can go above 1000 nm. The light source 202 emits light 206 incident to a first side 210 of the print medium 108, some of which is transmitted through the print medium 108 as the print medium 108 advances between the light source 202 and the transmissive optical sensor 204. The portion of the light 206 that is transmitted through the print medium 108 is identified as the transmitted light 208.

When the print medium 108 is not currently between the light source 202 and the transmissive optical sensor 204, then the transmitted light 208 includes substantially all of the emitted light 206. Where print medium 108 is currently between the light source 202 and the transmissive optical sensor 204, then the transmitted light 208 includes the portion of the emitted light 206 that is transmitted through the print medium 108. When the portion of the print medium 108 having the barcode is currently between the light source 202 and the transmissive optical sensor 204, the transmitted light 208 includes the portion of the emitted light 206 that is transmitted through the minimally transmissive barcode and the print medium 108, as opposed to that portion of the emitted light 206 that is blocked and/or absorbed by the barcode. The light transmitted 208 through the barcode encodes one or more types of information about the print medium 108.

The transmissive optical sensor 204 may include, but are not limited to, one or more phototransistors, or other types of optical sensors. Examples of such optical sensors include photodetectors and optical light sensors. The transmissive optical sensor 204 detects, or senses, the transmitted light 208 that passed out of the second side 212 of the print medium 108 opposite the first side 210 thereof. In other words, the transmissive optical sensor 204 detects the portion of light 206 emitted by the light source 202 that is transmitted through the print medium 108 as transmitted light 208. The transmissive optical sensor 204 thus is able to detect changes in the transmitted light 208 as the print medium 108 and the barcode pass between the light source 202 and the optical sensor 204. The transmissive optical sensor 204 provides a sensor signal corresponding to the level of transmitted light 208.

FIG. 3A illustrates a top view of a representative embodiment of the print medium 108. The barcode 110 is disposed on the first side 210 (backside) of the print medium 108. The barcode 110 is positioned to be on the first edge to be advanced through the transmissive sensor assembly 106 so that the encoded information can be decoded and a print mode selected before the print medium 108 enters the print zone. In another embodiment, the barcode can be positioned in one or more different positions on the print medium.

For example, blank space is shown in FIG. 3A between the barcode 110 and the leading edge of the print medium 108. In another embodiment, the barcode 110 can extend all the way to the edge of the print medium 108. Further, the barcode 110 can be other shapes and sizes than that shown in FIG. 3A. For example, the barcode 110 is shown in FIG. 3A as being substantially square. The barcode 110 can also be, but is not limited to, rectangular, circular, elliptical, and the like, in shape.

FIG. 3B illustrates a cross-sectional view of another representative embodiment of the print medium 108. The print medium 108 can include, but is not limited to, a substrate 302 having a minimally transmissive barcode 110 and an ink-receiving layer 304. The barcode 110 may be disposed on the backside 308 (as opposed to the frontside 306) of the print medium 108 (FIG. 3A) or in between the substrate 302 and the ink-receiving layer 304 (FIG. 3B). As illustrated in FIG. 3B, the ink-receiving layer 304 is disposed on the substrate 302 and barcode 110 so that the barcode 110 is positioned between the substrate 302 and the ink-receiving layer 304. The ink-receiving layer 304 can include, but is not limited to, microporous, inorganic particles, and/or a binder.

The term “substrate” 302 refers to print medium substrates that can be coated with the ink-receiving layer 304 in accordance with embodiments of the present disclosure. The substrate 302 can include, but is not limited to, paper substrates, photobase substrates, plastic substrates (e.g., clear to opaque plastic film), and the like. The substrate 302 may include, but is not limited to, a hard or flexible material made from a polymer, a paper, a glass, a ceramic, a cloth (e.g., woven and non-woven material), craft materials (e.g., wood, poster board, signs, and the like), compact discs, and digital video discs.

The term “barcode” 110 refers to one or more types of machine-readable representations of at least one type of information about the print medium 108. The barcode 110 includes a barcode material that can include, but is not limited to, an ink, a metal, a dye, and/or a substance which is minimally transmissive of the light 206 emitted from the light source 202. The barcode 110 may be opaque or invisible.

The barcode 110 may be encoded with one or more types of information about the print medium. The barcode 110 could be encoded with information about the print medium 108 such as, but not limited to, type of medium (e.g., swellable or porous), color map information, media size, media orientation, sidedness, or improper loading of media. In addition, the print medium 108 may contain multiple barcodes containing different information about the print medium 108 at several positions on the print medium 108. For example, the print medium 108 may have a first barcode indicating media type at a first position and a second barcode indicating improper loading at second position on the print medium 108. Further, a single barcode could provide information about multiple features of the print medium.

The barcode 110 can use one or more types of encoding. For instance, the barcode 110 may be encoded using a synchronous scheme (e.g., Manchester encoding), an alternate mark inversion, pulse-code modulation or other encodings that are machine-readable. Furthermore, the barcode 110 can be of variable bit widths and can include a calibration bit, a start bit, or other types of bits. Moreover, an asynchronous scheme could also be used, using specific ink patterns to produce a clock signal and data signal.

The term “ink-receiving layer” 304 refers to a layer that includes microporous, inorganic particles that can be disposed (e.g., coated) on the substrate 302 and barcode 110. The ink-receiving layer 304 is configured to receive ink within the pores provided by the microporous, inorganic particles. The ink-receiving layer 304 can be from about 20-50 grams per square meter (GSM), and swellable media can be between about 10 and 25 GSM.

One embodiment of print medium 108 may be produced by providing a substrate, disposing a barcode material on the substrate 302, and encoding one or more types of information corresponding to the print medium 108 to form a barcode 302 from the barcode material. Furthermore, an ink-receiving layer 304 may be disposed on the barcode material and substrate 302, thereby enclosing the barcode 110. Alternatively, another embodiment of the print medium 108 may be produced by providing a substrate 302, disposing a barcode material on the substrate 302, and encoding one or more types of information corresponding to the print medium 108 to form a barcode 302 from the barcode material, where the barcode is on the exterior of the print medium 108.

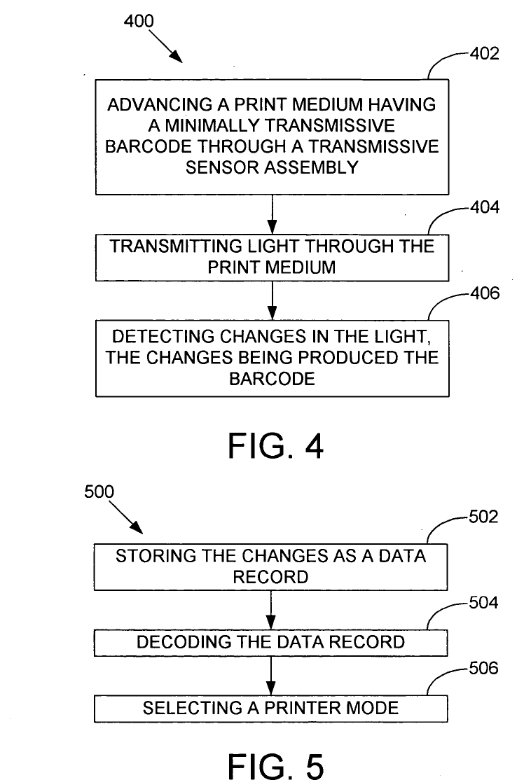

FIG. 4 is a flow diagram describing a representative method 400 for printing on the print medium 108 using the printer system 100. In block 402, the print medium 108, having minimally transmissive barcode 110, is advanced through the transmissive sensor assembly 106. In block 404, a light 206 at a set of wavelengths is transmitted through the print medium 108. The wavelengths of light 206 include the set of wavelengths minimally transmitted and/or substantially absorbed by the barcode 110. In block 406, changes in the light 206 transmitted through the print medium 108 are detected, as a portion of the light 206 is blocked and/or absorbed by the barcode 110 and/or the print medium 108.

FIG. 5 illustrates a flow diagram of a representative embodiment 500 for using the changes in light detected by the transmissive sensor assembly 106 to select a print mode. In block 502, the changes detected are stored as a data record. In block 504, the data record is decoded to determine the information about the print medium 108. In block 506, a printer mode corresponding to the print medium 108 is selected based upon the data record. Alternatively, an embodiment could decode the data record as indicating sidedness/upside down orientation or improper loading/rotation of the print medium 108 and indicate an error.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to 5%” should be interpreted to include not only the explicitly recited concentration of about 0.1 wt % to 5 wt %, but also include individual concentrations (e.g., 1%, 2%, 3%, and 4%) and the sub-ranges (e.g., 0.5%, 1.1%, 2.2%, 3.3%, and 4.4%) within the indicated range.

Many variations and modifications may be made to the above- described embodiments. All such modifications and variations are intended to be included herein within the scope of this disclosure and protected by the following claims.

At least the following is claimed:

1. A method comprising:
advancing a portion of a print medium through a transmissive sensor assembly, the portion of the print medium having a barcode, the barcode being minimally transmissive of a set of light wavelengths, and the barcode being encoded with at least one type of information corresponding to the print medium;
transmitting light at the set of light wavelengths substantially absorbed by the barcode through the print medium; and
detecting changes in the light transmitted through the print medium, the changes being produced by the barcode.

2. The method of claim 1, wherein the barcode is substantially absorptive of the set of light wavelengths.

3. The method of claim 1, further comprising:
storing the changes detected along the length of the barcode as a data record; and
decoding the data record to determine the information about the print medium.

4. The method of claim 3, further comprising:
indicating an error in loading of the print medium into a printer into which the print medium is advanced.

5. The method of claim 3, further comprising:
selecting a print mode compatible with the print medium based on the data record, wherein the print mode is selected without user input.

6. The method of claim 1, wherein decoding the data record to determine the information about the print medium further includes determining an item of information selected from: porous/swellable differentiation, color map, size, orientation, sidedness, improper loading, and combinations thereof.

7. A printer system for communicating information about a print medium, comprising:
a transmissive sensor assembly configured to emit light and detect the light being transmitted through the print medium having a barcode, the barcode being minimally transmissive of the light and encoded with the information corresponding to the print medium, and wherein the transmissive sensor assembly comprises a light source element and an optical sensor element.

8. The printer system of claim 7, wherein the barcode is substantially absorptive of the set of light wavelengths.

9. The printer system of claim 7, wherein the light source element includes a source selected from: a fluorescing gas light source, an incandescent light source, a filament light source, a halogen light source, and combinations thereof.

10. The printer system of claim 7, wherein the optical sensor element includes a sensor selected from: photodetectors, optical light sensors, and combinations thereof.

11. The printer system of claim 7, wherein the transmissive sensor assembly is configured to emit near-infrared light and detect the near-infrared light being transmitted through the print medium.

12. The printer system of claim 11, wherein the near-infrared light has a wavelength from about 860 nanometers (nm) to 1000 nm.

13. The printer system of claim 7, further comprising:
a computer control system communicatively coupled to the transmissive sensor assembly, the computer control system configured to collect and decode data from the light, and the printer system has a plurality of print modes.

14. The printer system of claim 7, wherein the printer system includes a printer selected from: ink-jet printers, dot matrix printers, and dye-sublimation printers, laser printers, and combinations thereof.

15. A print medium, comprising:
a barcode, the barcode being minimally transmissive of a set of light wavelengths, and the barcode being encoded with at least one type of information corresponding the print medium.

16. The print medium of claim 15, wherein the barcode is substantially absorptive of the set of light wavelengths.

17. The print medium of claim 16, wherein the barcode is substantially absorptive of a set of light wavelength in a near infrared light wavelength is from about 840 nanometers (nm) to 1000 nm.

18. The print medium of claim 16, wherein the barcode comprises a material selected from: a metal film, an ink, a dye, a toner, and combinations thereof.

19. The print medium of claim 15, further comprising a substrate, and wherein the barcode is disposed on the substrate.

20. The print medium of claim 19, further comprising an ink-receiving layer disposed on the substrate and the barcode, and wherein the barcode is enclosed by the substrate and the ink-receiving layer.

21. The print medium of claim 19, wherein the barcode disposed on the substrate is on the exterior of the print medium.

22. A method comprising:
providing a print medium; and
disposing a barcode material on the print medium, the barcode material being minimally transmissive to a set of light wavelengths; and
forming a barcode with the barcode material, wherein the barcode encodes at least one type of information corresponding to the print medium.

23. The method of claim 22, wherein the print medium includes a substrate and an ink-receiving layer and further comprising:
disposing an ink-receiving layer on the barcode material and substrate.

24. The method of claim 22, further comprising:
reading the encoded material relating to the information about the print medium; and
adjusting at least one printing parameter automatically without user input based on the read information from the print medium in a printer system.
